(19) United States
(12) Patent Application Publication
(10) Pub. No.: US 2009/0306310 A1
(43) Pub. Date: Dec. 10, 2009

(54) Method of using click chemistry to functionalize dendrimers

(75) Inventors: Peng Wu, Berkeley, CA (US); Valery Fokin, Oceanside, CA (US); K. Barry Sharpless, La Jolla, CA (US)

Correspondence Address: Olson & Cepuritis, LTD., 20 NORTH WACKER DRIVE, 36TH FLOOR, CHICAGO, IL, 60606, US

(73) Assignee: The Scripps Research Institute, La Jolla, CA (US)

(21) Appl. No.: 11/989,073

(22) PCT Filed: Jul. 18, 2006
(86) PCT No.: PCT/US06/27924

§ 371 Date: May 12, 2009

Related U.S. Application Data
(60) Provisional application No. 60/700,483, filed on Jul. 18, 2005.

(51) Int. Cl. C08F 291/06; C08G 65/00

(52) U.S. Cl. 525/540; 525/50; 528/86; 528/211

(57) ABSTRACT

A library of functionalized dendritic macromolecules was prepared in extremely high yields using no protecting group strategies and with only minimal purification steps through the use of copper(I)-catalyzed 1,3-dipolar cycloaddition of azides and terminal acetylenes.

### TECHNICAL FIELD

The invention relates to dendrimers and to a method for functionalizing dendrimers. More particularly, the invention relates to the use of click chemistry for functionalizing dendrimers.

### BACKGROUND

A dendrimer is a polymer having a regular branched structure of a fractal nature. As an inherent consequence of their fractal nature, dendrimers have a large number of functional groups at their chain ends or periphery. (Bosman, A. W., et al., Chem. Rev. 1999, 99, 1665-1688; Grayson, S. M., et al., Chem. Rev. 2001, 101, 3819-3868; Hecht, S. J. Polym. Sci., Polym. Chem. 2003, 41, 1047-1058; Fréchet, J. M. J. J. Polym. Sci., Polym. Chem. 2003, 41, 3713-3725; Tomalia, D. A., et al., Angew. Chem., Int. Ed. 1990, 29, 138-175; Gudipati, C. S., et al., J. Polym. Sci., Polym. Chem. 2004, 42, 6193-6202; and Percec, V., et al., J. Am. Chem. Soc. 2003, 125, 6503-6516) In repeated studies, the nature of these chain ends have been shown to strongly dictate the chemical and physical properties of dendritic macromolecules. (Zimmerman, S. C., et al., J. Am. Chem. Soc. 2003, 125, 13504-13518; Kimata, S., et al., J. Polym. Sci., Polym. Chem. 2003, 41, 3524-3530; Dahan, A., et al., Macromolecules 2003, 36, 1034-1038; Harth, E. M., et al., J. Am. Chem. Soc. 2002, 124, 3926-3938; Pochan, D. J., et al., Macromolecules 2002, 35, 9239-9242; and Mackay, M. E., et al., Langmuir 2002, 18, 1877-1882) As a result, the central dendritic framework acts as a scaffold and the final properties and applications of the dendrimer are primarily determined by the numerous chain end functional groups. This novel characteristic of dendritic macromolecules, when compared to traditional linear polymers, is perhaps best represented by the PAMAM dendrimers of Tomalia (Kobayashi, H., et al., Cancer Res. 2003, 63, 271-276; and Dendritic Nanotechnologies web page, http://www.dnanotech.com) or the DAB dendrimers from DSM/Meijer (Jansen, J. F. G. A., et al., Science 1994, 266, 1226-1229; and Froehling, P., J. Polym. Sci., Polym. Chem. 2004, 42, 3110-3115) where a myriad of different structures have been prepared by modification of the chain end amino groups. The most dramatic illustration of this ability to tune the properties and hence, applications of dendritic macromolecules emerges from the distinctly different areas of medicinal chemistry and semiconductors. For example, a novel dendritic HIV/AIDS drug from Starpharma is based on a PAMAM scaffold with sulphonic acid end groups, (Matthews, B. R., et al., U.S. Pat. No. 6,190,650, Feb. 20, 2001) while the same PAMAM dendritic scaffolds with oligio(ethylene glycol) end groups are used as pore generating agents in the development of dielectric thin films for advanced microelectronic devices. (Hawker, C. J., et al., MRS Bull. 2000, 25, 54)

The importance of chain end groups in dendrimer technology is significant and widely acknowledged. (Haba, Y., et al., J. Am. Chem. Soc. 2004, 126, 12760-12761; Beil, J. B., et al., J. Am. Chem. Soc., in press; Gillies, E. R., et al., J. Org. Chem. 2004, 69, 46-53; Furuta, P., et al., J. Am. Chem. Soc. 2003, 125, 13173-13181; and Wooley, K. L., et al., Macromolecules 1993, 26, 1514-1519) However, little effort has been devoted to the development of a general approach to the functionalization of dendritic macromolecules. Traditionally, the selection of functionalization chemistry is tailored to a specific dendrimer scaffold or a target moiety to be introduced and requires that numerous synthetic issues be addressed to be successful. (Shu, C.-F., et al., Macromolecules 1999, 32, 100-105; Malkoch, M., et al., Macromolecules 1999, 32, 100-105; and Malkoch, M., et al., J. Polym. Sci., Polym. Chem. 2004, 42, 1758-1765) For example, the highly functionalized nature of the dendritic core leads to incomplete and partially functionalized dendrimers if the chosen reactions are not quantitative. In addition, a lack of compatibility with the repeat units of the dendritic core can lead to cleavage and destruction of the dendrimer. These issues become exacerbated for higher generation dendrimers where the large numbers of chain ends and internal linkages amplifies the effect of any side reactions or incomplete functionalizations. For example, an average selectivity of 99%, in the functionalization of a [G-5]₃-[C] poly(benzyl ether) dendrimer with 96 chain ends, only results in a 38% yield of fully functionalized dendrimer. (Hummelen, J. C., et al., Chem. Eur. J. 1997, 3, 1489-1493) To overcome this incomplete functionalization, an extremely large excess of reagents has to be used, however this severely compromises the efficiency of the synthesis and in turn leads to purification problems.

What is needed for greatest versatility and efficiency is the development of a general approach to dendrimer functionalization that employs a reaction that occurs with quantitative yields, under mild reaction conditions and be compatible with essentially all potential surface functional groups and internal dendritic repeat units. Unfortunately, many of the current synthetic approaches to dendrimer functionalization do not satisfy all, or in some cases any of these criteria. What is needed is a versatile and highly efficient approach to the functionalization of dendrimers which proceeds with absolute fidelity, high levels of control and functional group compatibility. What is needed is a novel strategy based on the copper(I)-catalyzed triazole formation for the functionalization of dendrimers that fulfils all of these goals.

### SUMMARY

A library of functionalized dendritic macromolecules was prepared in extremely high yields using no protecting group strategies and with only minimal purification steps through the use of copper(I)-catalyzed 1,3-dipolar cycloaddition of azides and terminal acetylenes. This unprecedented ability to routinely prepare functionalized dendrimers represents a significant advance compared to traditional approaches and is further evidence of the synthetic utility of click chemistry in both biological systems and materials chemistry.

One aspect of the invention is directed to a process for functionalizing a dendrimer having a periphery with multiple chain ends. The process employs the step of attaching a functional group to all chain ends by means of a click chemistry reaction to form a functionalized dendrimer. In a preferred mode, the click chemistry reaction is a 1,3-dipolar cycloaddition of a terminal acetylene with an azide to form a [1,2,3]-triazole. The multiple chain ends may each have a terminal acetylene or, alternatively, may each have an azide.

Another aspect of the invention is directed to an improved dendrimer having a periphery with multiple chain ends. In this aspect of the invention, the multiple chain ends are each characterized by having a terminal acetylene.

Another aspect of the invention is directed to an improved dendrimer having a periphery with multiple chain ends. In this aspect of the invention, the multiple chain ends are each characterized by having an azide.

Another aspect of the invention is directed to an improved dendrimer having multiple terminal branch points and a periphery consisting of multiple terminal chains. Each terminal chain corresponds to and is attached to one of the terminal branch points. Each terminal chain has a chain end. In this aspect of the invention, each terminal chain is characterized by incorporating a [1,2,3]-triazole ring between its corresponding branch point and its chain end.

### BRIEF DESCRIPTION OF DRAWINGS

FIG. 1 illustrates a scheme showing the synthesis of successive generations of dendrons based on the well known 3,5-dioxybenzyl ether 2.7.

FIGS. 2a, 2b and 2c illustrate a scheme where the coupling of the dendrons to a trifunctional core 2.13 gives the desired dendrimers 2.15-2.18 and propargylation of the core 2.13 gives the compound 2.14.

FIG. 3 illustrates a proton NMR spectrum for the fourth generation dendrimer (Acet)₄₈-([G-4])₃-[C], 2.18.

FIG. 4 illustrates a scheme showing the functionalization of the commercially available, hyperbranched polyester based on 2,2-bis(hydroxymethyl)propionic acid (bis MPA) (Boltorn) with pent-4-ynoyl anhydride, 2.53.

FIG. 5 illustrates a reaction showing the functionalization of the hexaacetylene-terminated polyether dendrimer, 2.15, with a simple azido-derivative, 1-azidoadamantane 2.19.

FIG. 6 illustrates a GPC trace showing a clean transition to a higher molecular weight product, 2.37, which is observed with no detectable amount of starting dendrimer, 2.15.

FIG. 7 illustrates the structures of some highly functionalized azides for reaction with acetylene-terminated dendrimers.

FIGS. 8a and 8b illustrate tables showing the purified yields obtained for the preparation of chain end functionalized dendrimers from a variety of different azido derivatives, 2.19-2.31, and dendritic core.

FIG. 9 illustrates a reaction showing the functionalization of the 3^{rd} generation dendrimer, 2.17, which contains 24 terminal acetylene groups with methyl 4-(azidomethyl)benzoate, 2.23.

FIG. 10 illustrates a proton NMR of 2.43.

FIG. 11 illustrates the reaction of the dodeca-acetylene polyether dendritic core, 2.16, with 3′-azido-3′-deoxythymidine, 2.28, to give the nucleoside-terminated dendrimer, 2.41, in 94% yield.

FIG. 12 illustrates a sequential series of reactions leading to the synthesis of 2.52.

FIG. 13 illustrates a typical MALDI spectrum for an acetylene-terminated starting material for the dodecafunctionalized bis-MPA dendritic polyester, 2.56.

FIG. 14 illustrates a MALDI spectrum after triazole functionalization with azido mannose derivative, 2.25, in THF.

### DETAILED DESCRIPTION

The key to the development of a general and efficient approach to dendrimer functionalization is the use of click chemistry, specifically the copper(I)-catalyzed regiospecific formation of [1,2,3]-triazoles from azides and terminal acetylenes. The unprecedented degree of control provided by this transformation is perfectly suited to polymeric materials. In direct contrast with small molecule chemistry, one of the greatest challenges in polymer chemistry is the ability to perform multiple functionalization reactions without crosslinking (side reactions) or incomplete functionalization occurring. The occurrence of even minor amounts of crosslinking (ca. 1-3%) can lead to gelation due to the numerous functional groups along the backbone, while the inability to separate unreacted functional groups is a significant issue. Dendrimers, due to their high functionality and monodisperse nature, are perfect test vehicles to probe the fidelity of the copper(I)-catalyzed cycloaddition as a functionalization tool in polymeric systems since crosslinking reactions or unreacted starting groups can be detected at less than 1%.

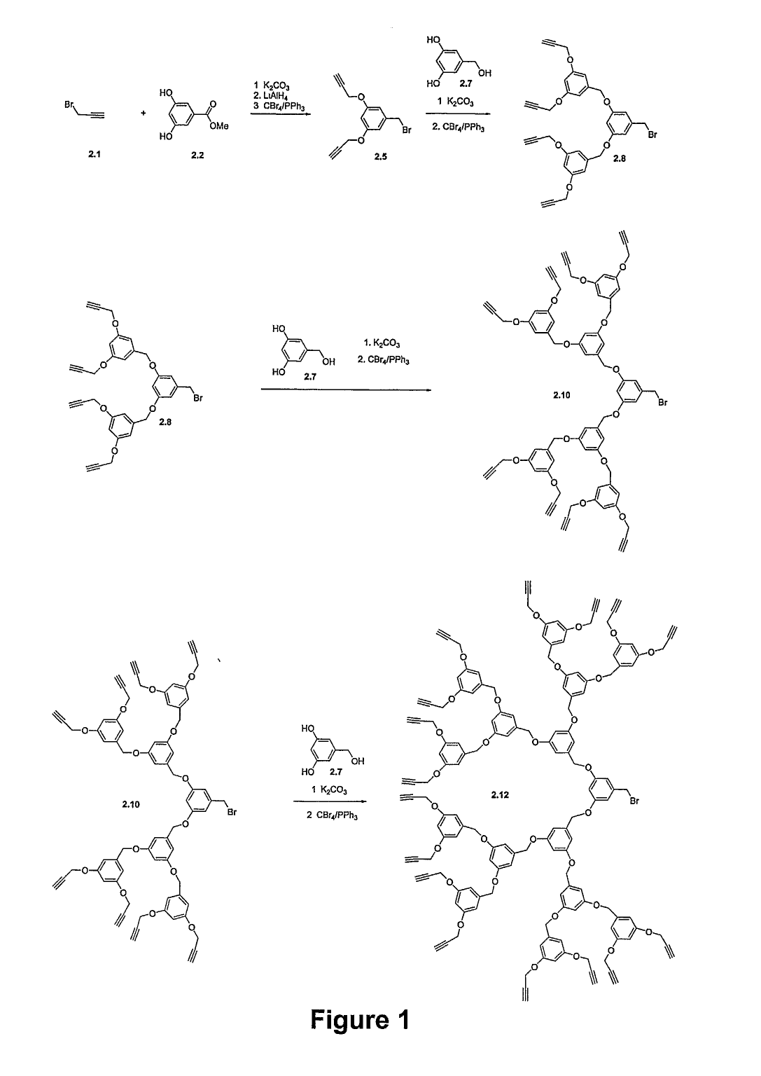

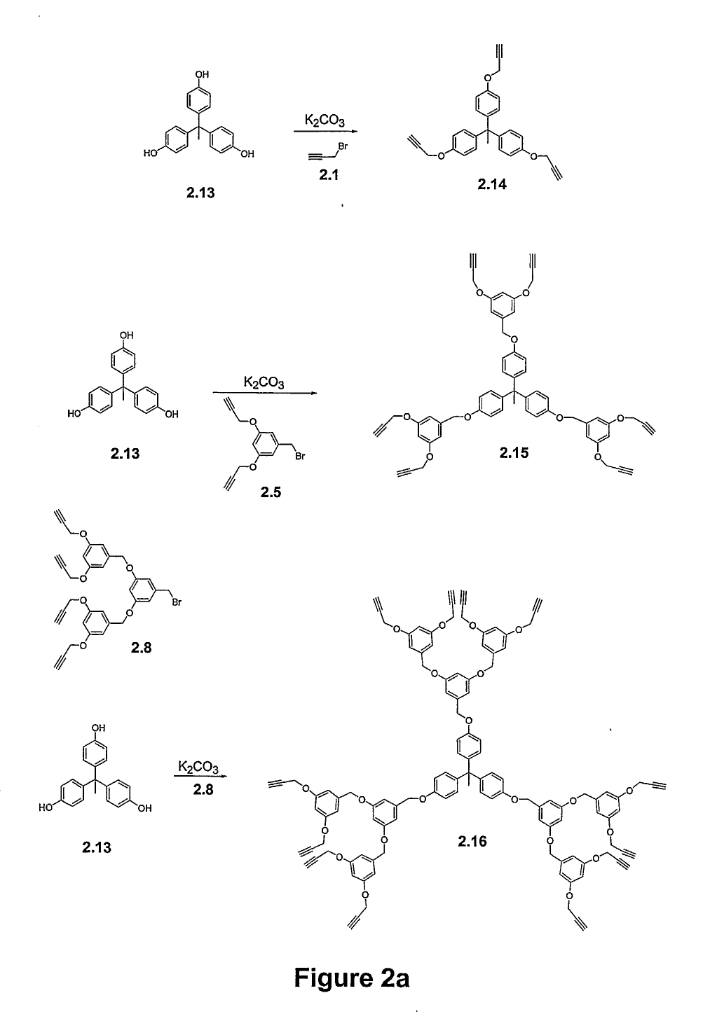

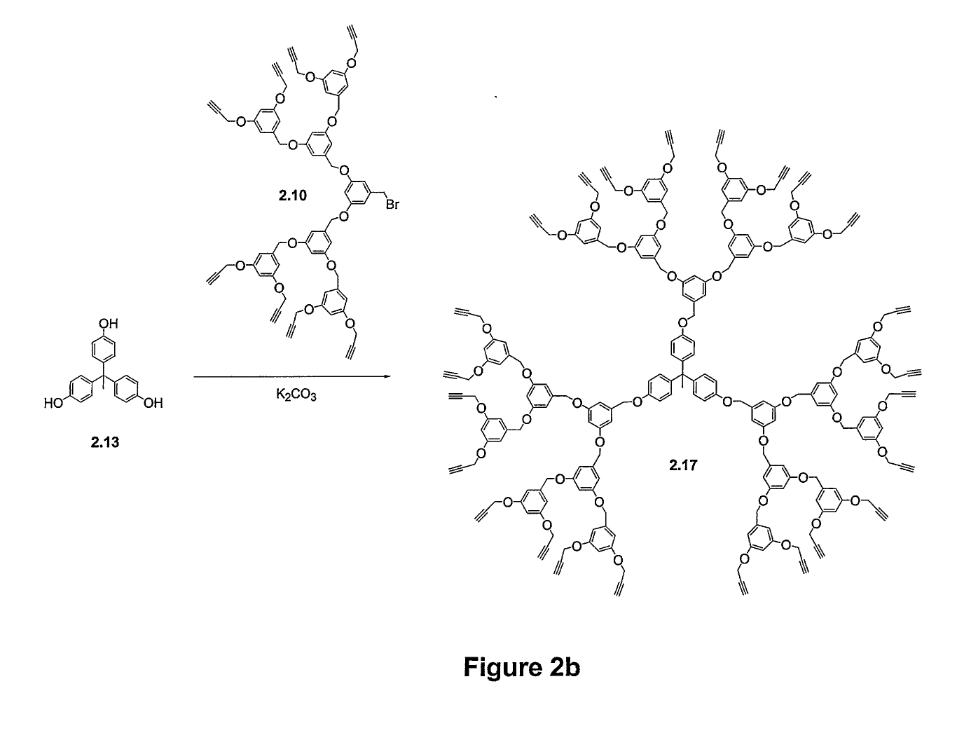

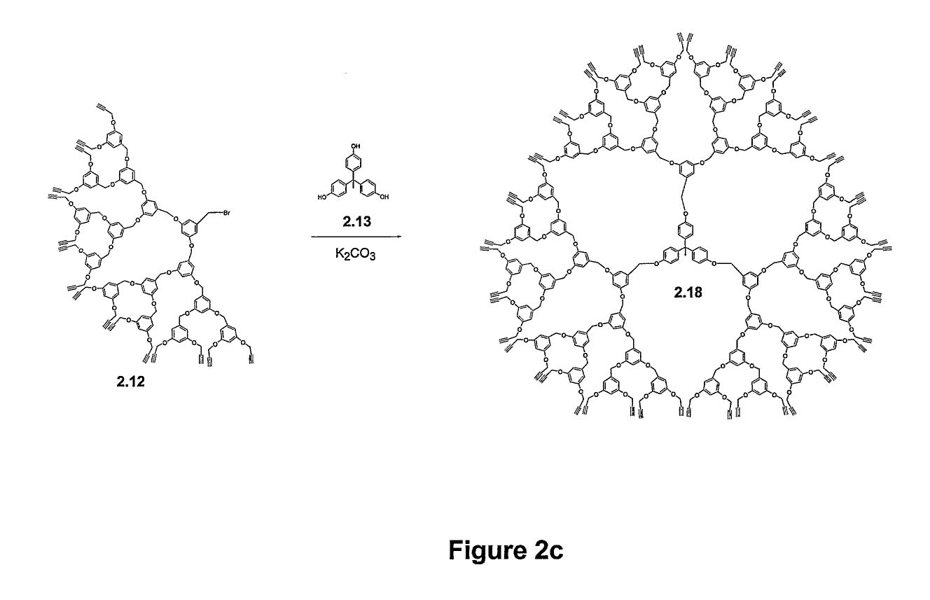

In designing dendrimers for functionalization by the copper(I)-catalyzed triazole chemistry, either acetylene or azide terminated dendritic macromolecules can be envisaged. The ready availability of propargyl derivatives and the compatibility of acetylenic groups with a variety of chemical transformations led to the selection of acetylene terminated dendrimers as the 3-dimensional scaffold for functionalization. Initially the well known 3,5-dioxybenzyl ether dendrimers (Harth, E. M., et al., J. Am. Chem. Soc. 2002, 124, 3926-3938; Kimata, S., et al., J. Polym. Sci., Polym. Chem. 2003, 41, 3524-3530; Sivanandan, K., et al., J. Org. Chem. 2004, 69, 2937-2944; and Li, S., et al., J. Am. Chem. Soc. 2003, 125, 10516-10517) were selected as cores and these were prepared using a traditional convergent growth approach (Hawker, C. J., et al., J. Am. Chem. Soc. 1990, 112, 7638-7645) with the respective dendrons from generation 1 to 4 being obtained in excellent yields (FIG. 1). Coupling of these acetylene terminated dendrons to a central trifunctional core, 2.13, then gave the desired dendrimers 2.14-2.18, with 3, 6, 12, 24 and 48 chain end acetylene groups respectively (FIGS. 2A, 2B, 2C).

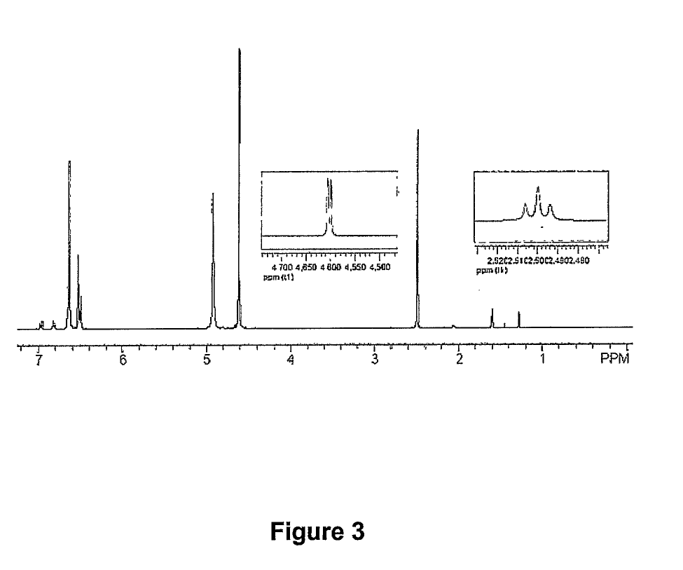

Characterization of the acetylene terminated dendrimers by standard techniques showed that the structures were monodisperse with physical properties similar to the extensively studied, benzyl ether terminated, Frëchet type dendrimers. (Harth, E. M., et al., J. Am. Chem. Soc. 2002, 124, 3926-3938; Kimata, S., et al., J. Polym. Sci., Polym. Chem. 2003, 41, 3524-3530; Sivanandan, K., et al., J. Org. Chem. 2004, 69, 2937-2944; and Li, S., et al., J. Am. Chem. Soc. 2003, 125, 10516-10517) For example, the solubility was extremely high in common organic solvents such as tetrahydrofuran, dichloromethane, toluene, etc. and the glass transition temperature for the higher molecular weight derivatives was ca. 20° C. which is similar to the Tg value of 42° C. reported for similar molecular weight, Frëchet-type dendrimers. (Beil, J. B., et al., J. Am. Chem. Soc., in press) The unique resonances for the terminal propargyl units were readily observed in the ¹H NMR spectra of 2.14-2.18 with the acetylene proton appearing as a triplet at ca. 2.50 ppm and the propargyl-CH₂ as a sharp doublet at ca. 4.60 ppm. These unique resonances can be seen for the 4^{th} generation dendrimer, 2.18, which also shows the classical resonances for the internal 3,5-dioxybenzyl ether repeat units (4.90 and 6.4-6.7 ppm) and the trifunctional core (2.05 and 6.80-7.00 ppm) (FIG. 3).

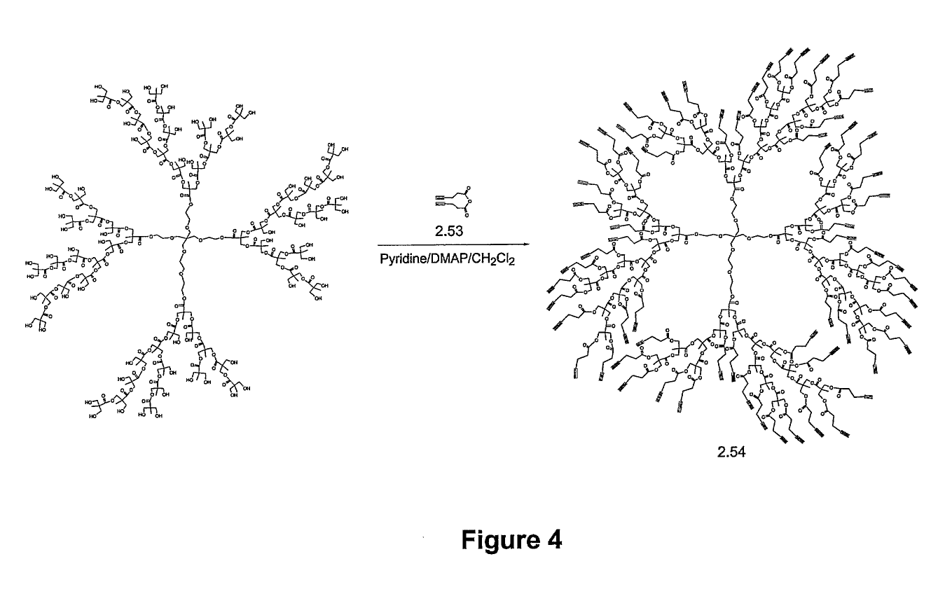

The facile preparation of chain end functionalized poly(benzyl ether) dendrimers demonstrates that introduction of terminal acetylene groups into a dendritic structure is readily accomplished. This point was further demonstrated by the chain end modification of divergent PAMAM/DAB dendrimers, bis-MPA dendrimers and hyperbranched polyesters with terminal acetylene groups. The terminal acetylenes were introduced by amidation or esterification of the chain end amino or hydroxyl groups, and the availability of a wide variety of acetylenic precursors was instrumental in preparing these derivatives. As shown in FIG. 4, reaction of the commercially available, hyperbranched polyester (Malmström, E., et al., Macromolecules 1995, 28, 1698-1703; Malkoch, M., et al., Macromolecules 2002, 35, 8307-8314; and Jesberger, M., et al., J. Polym. Sci., Polym. Chem. 2003, 41, 3847-3861) based on 2,2-bis(hydroxymethyl)propionic acid (bis-MPA) (Boltorn®) with pent-4-ynoyl anhydride, 2.53, affords the desired acetylene terminated derivative, 2.54, in quantitative yield.

Having demonstrated the incorporation of different dendritic cores with terminal acetylene chain ends, periphery functionalization with 1,4-substituted triazole rings by copper(I) catalysis was examined. While azido derivatives are arguably an overlooked functional group in the literature, many examples are either commercially available or easily synthesized by nucleophilic displacement of alkyl halides with sodium azide. As a result, the power of this copper chemistry as a derivitization tool is significantly enhanced by the ready availability of both starting acetylene functionalized dendritic macromolecules and functionalized azido groups.

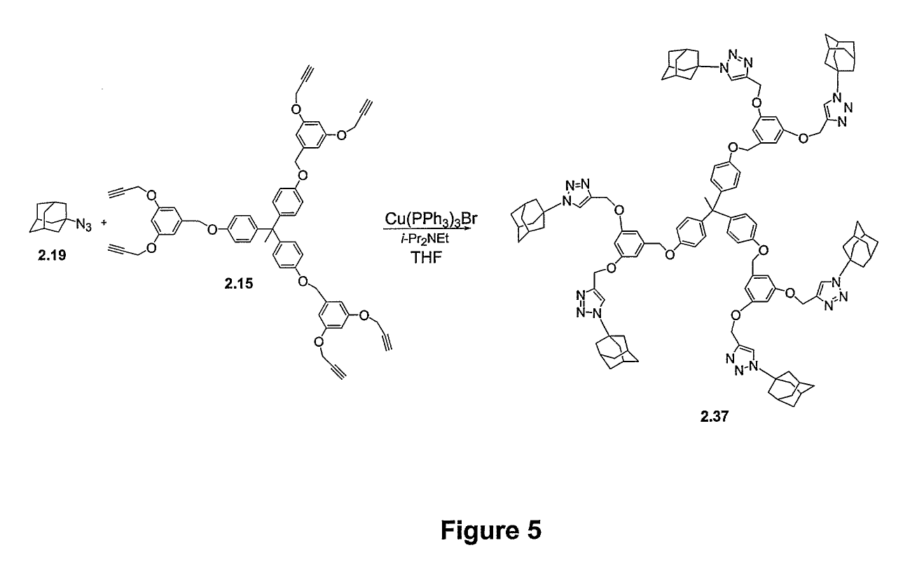

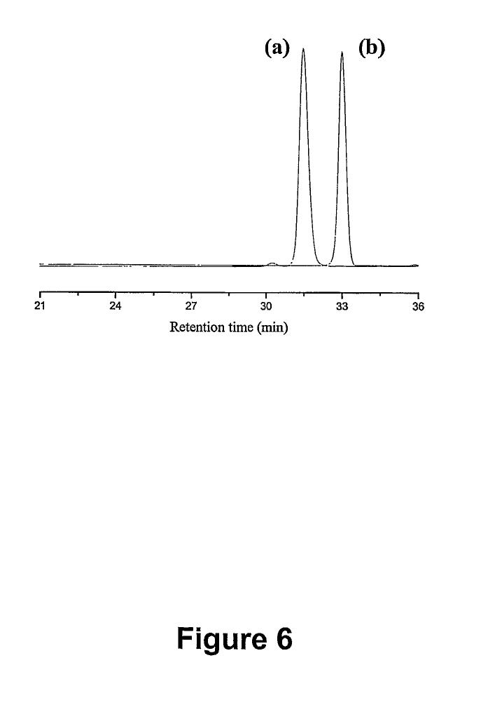

Initially, the functionalization of the hexaacetylene-terminated polyether dendrimer, 2.15, with a simple azido-derivative, 1-azidoadamantane 2.19, was examined. Under standard conditions, CuSO₄/sodium ascorbate in aqueous solution, no reaction was observed due to the insolubility of the starting materials in the reaction mixture. As we have demonstrated previously, (Wu, P., et al., Angew. Chem., Int Ed. 2004, 43, 3928-3932) this incompatibility with aqueous reaction conditions can be overcome by employing an organosoluble catalyst, [Cu(PPh₃)₃Br] or [(EtO₃)PCuI]. Reaction of the hexa-functionalized dendrimer, 2.15, with 9.0 equivalents of 2.19 in the presence of [(EtO)₃PCuI] under microwave irradiation for 10 minutes (Balderas, F. P., et al., Org. Lett. 2003, 5, 1951-1954) was found to give the desired hexa-adamantyl derivative, 2.37, in 72% yield after purification (FIG. 5). This result was significantly improved when the CuI catalyst was replaced with [Cu(PPh₃)₃Br]. In this case only a stoichiometric amount (6.0 equivalents) of azide was required to drive the reaction to completion and afford a 95+% yield of 2.37 after purification. The extremely high efficiency of the copper chemistry is evidenced by comparison of the GPC traces for the crude reaction product with the starting acetylene terminated dendrimer (FIG. 6).

A clean transition to a higher molecular weight product, 2.37, is observed with no detectable amount of starting dendrimer, 2.15, though under these forcing conditions, a small amount (<2%) of higher molecular weight product was observed at longer reaction times. This is presumably due to Cu-catalyzed coupling of terminal acetylene groups and it was found that decreasing the reaction time, using a slight excess of azide (1.02 equivalents per chain end) while working under more dilute conditions eliminated this minor side reaction. ¹H NMR spectroscopy of the crude dendrimer 2.37 obtained under these reaction conditions showed no resonances for unreacted terminal acetylenic groups, while MALDI-TOF mass spectral analysis showed a single molecular ion for the fully hexa-functionalized derivative, 2.37.

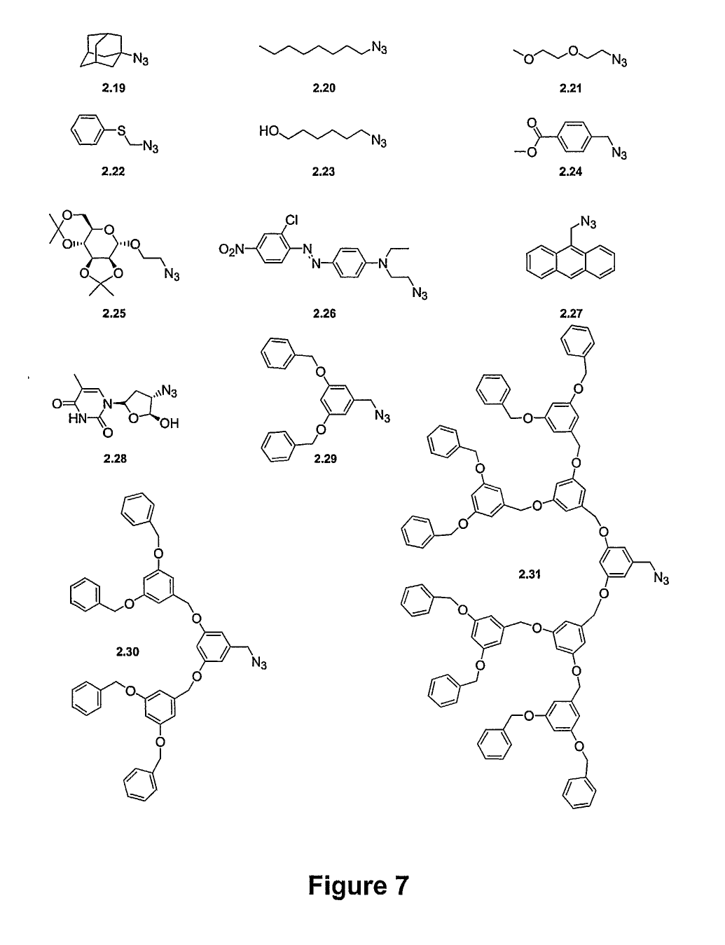

These promising initial results with a small dendrimer and a simple cycloaliphatic azide prompted a significant extension of this work to larger generation dendrimers and highly functionalized azides. In choosing the azido group, a wide selection of different structures incorporating reaction functional groups such as the nucleoside, 2.28, or the protected sugar, 2.25, dye molecules such as the Disperse Red azo derivative, 2.26, and even large dendrons, 2.29-2.31, were examined in order to show the compatibility of click chemistry with numerous functional groups (FIG. 7). Similarly, a variety of different dendritic structures from generation 2-4 polyether dendrimers, 2.16-2.18, to hyperbranched and dendritic polyesters, 2.54 and 2.56, and polyamino-based DSM dendrimers were studied in order to demonstrate both tolerance to different dendritic cores and the ability to fully functionalize high generation dendrimers with numerous chain end groups.

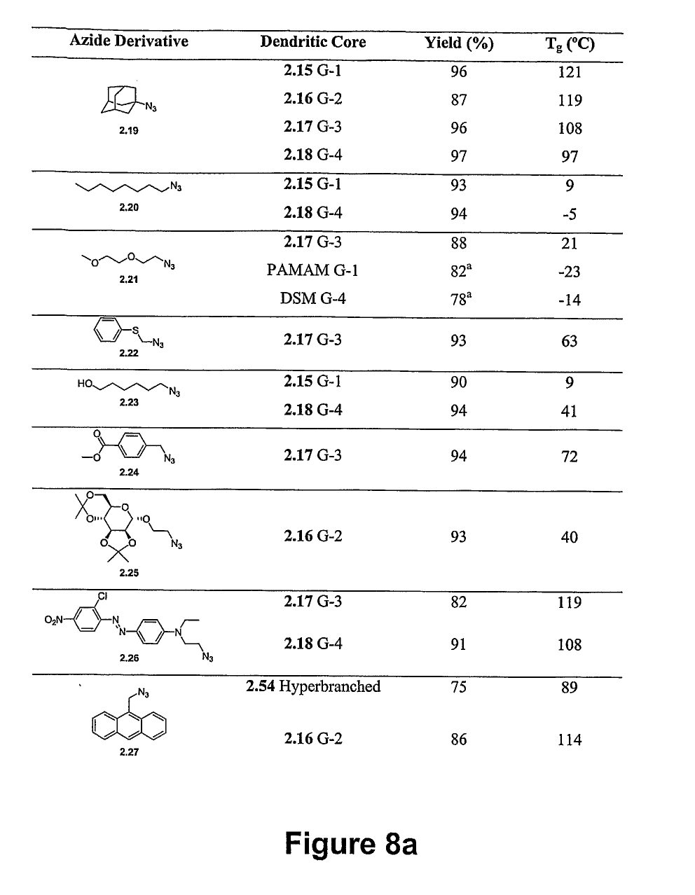

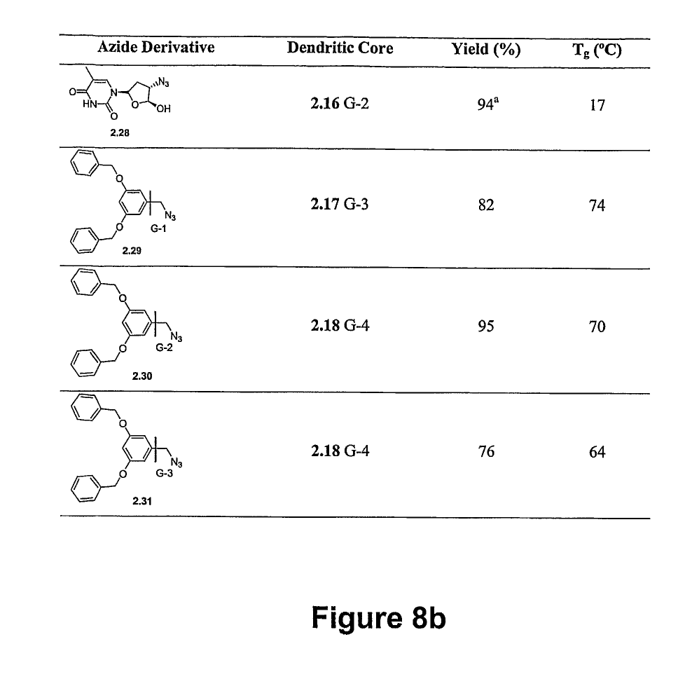

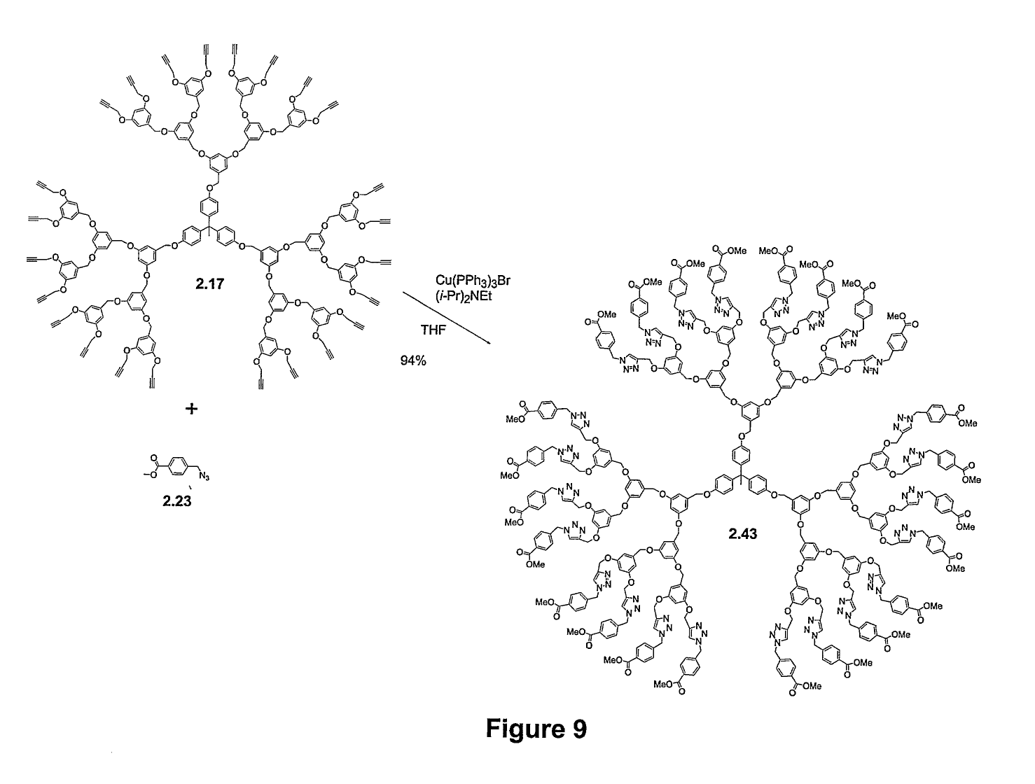

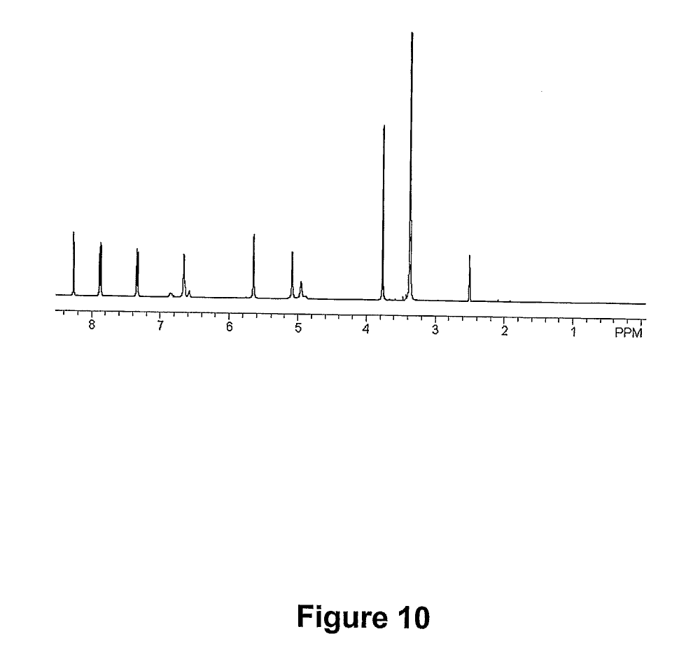

As shown in FIGS. 8A and 8B, the purified yields obtained for the preparation of chain end functionalized dendrimers from a variety of different azido derivatives, 2.19-2.31, and dendritic cores, using the copper catalyzed click chemistry were generally over 85-90%. Slightly lower yields were obtained in a small number of cases, however these more represent difficulties in the isolation and purification steps than incomplete reactions. The high efficiency of the methodology is perhaps best exemplified by the functionalization of the 3^{rd} generation dendrimer, 2.17, which contains 24 terminal acetylene groups with methyl 4-(azidomethyl)benzoate, 2.23. Microwave irradiation of a 1:25 mixture of 2.17 and 2.23 for 10 minutes was found to give, after purification by simple precipitation, a 94% yield of the fully functionalized dendrimer, 2.43 (FIG. 9). Characterization of 2.43 by a combination of spectroscopic and chromatographic techniques demonstrated the efficiency of the functionalization chemistry. Mass spectrometry showed a predominant molecular ion corresponding to complete substitution of the 24 peripheral acetylene groups, 2.43, (>97%) with only a very minor molecular ion (<3%) corresponding to a single unreacted acetylene group and no detectable ions for products with lower degrees of substitution. This efficiency of ca. 99.9% for each chain end functionalization reaction can be further appreciated in the ¹H NMR spectrum of 2.43 where no detectable resonances are observed for unreacted acetylene groups and unique resonances for the triazole rings (8.24 ppm), methyl benzoate groups (3.35 ppm) and dendritic core could be identified (FIG. 10). The high efficiency of this functionalization reaction is even more significant when it is compared with traditional dendrimer chemistry which employs large excesses of reagents to push the reactions to completion and requires extensive purification.

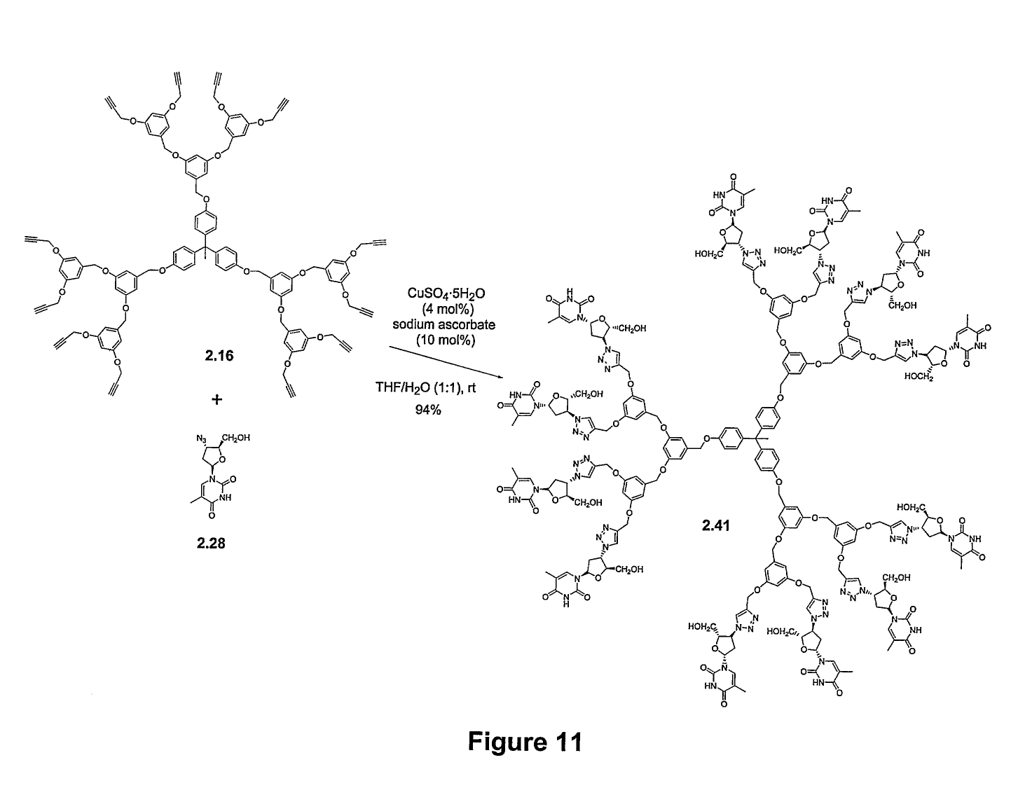

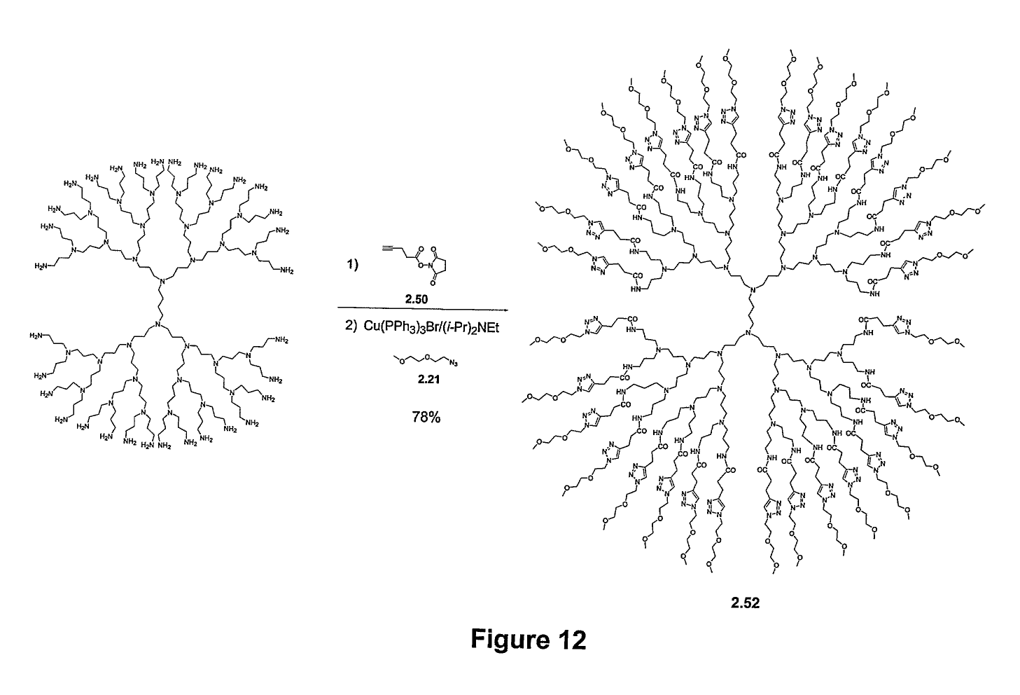

Other noteworthy examples which demonstrate the compatibility of this chemistry with highly functionalized groups were the reaction of the dodeca-acetylene polyether dendritic core, 2.16, with 3′-azido-3′-deoxythymidine, 2.28, to give the nucleoside-terminated dendrimer, 2.41, in 94% yield (FIG. 11). Significantly, no protection of the nucleoside, 2.28, was required and the reaction proceeded at room temperature in aqueous solution. Similarly, the polyether dendrimer core can be replaced by a 4^{th} generation DAB polyamine core and in a further demonstration of the compatibility of click chemistry, multiple reactions performed in the same reaction mixture. To illustrate this feature, a sequential series of reactions, initial acylation with the active ester of pent-4ynoic acid, 2.50, followed by triazole functionalization with the azido derivative of methoxy(diethylene glycol), 2.21, were conducted to give the functionalized DAB dendrimer, 2.52, in an overall yield of 78% (FIG. 12).

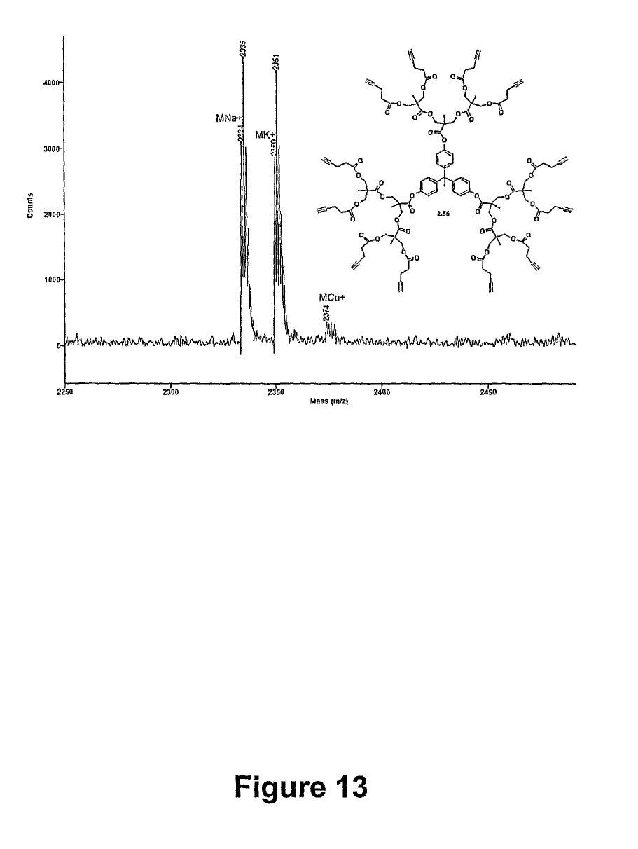

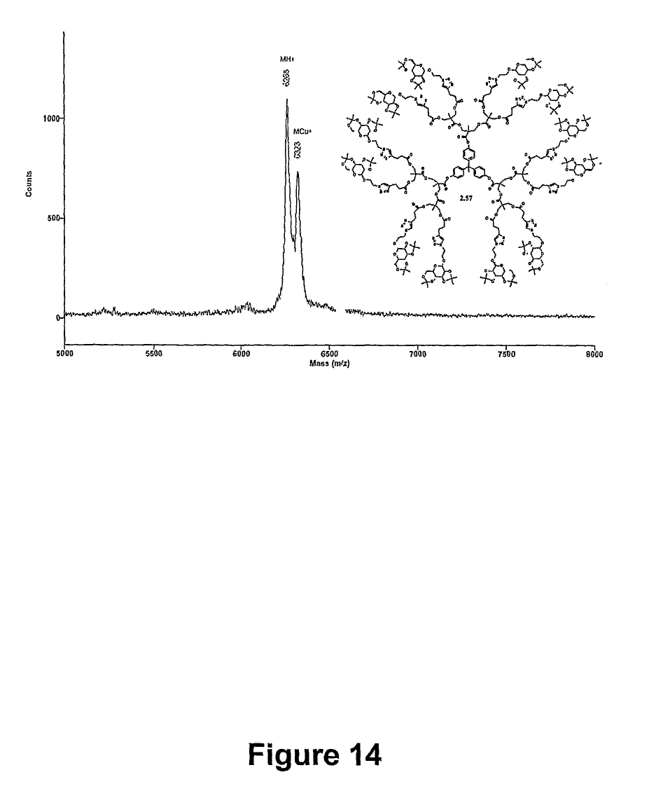

In developing the copper(I)-catalyzed cycloaddition reaction of azides with terminal acetylenes as a new and highly efficient polymer functionalization tool, significant attention was devoted to the precise characterization of these structures, especially in terms of the fidelity of chain end functionalization. The monodisperse nature of the dendritic starting materials permitted MALDI mass spectrometry to be used for detecting very low levels of incomplete functionalization of the chain end. A typical MALDI spectrum for an acetylene-terminated starting material is shown in FIG. 13 for the dodecafunctionalized bis-MPA dendritic polyester, 2.56, and shows a single set of molecular ions at 2312 (2335 MNa⁺, 2351 MK⁺, and 2374 MCu⁺). After triazole functionalization with azido mannose derivative, 2.25, in THF, the crude reaction mixture reveals that the peaks for the starting material are cleanly transformed to a single set of molecular ions at 6261 (6265 MH⁺ and 6323 MCu⁺) (FIG. 14). This corresponds to the decamannose, 2.57, and complete reaction at all of the chain ends. Incomplete reaction would be characterized by peaks at intervals of 329 amu less that the observed fully substituted product, and these are not observed, which again confirms the high fidelity of the copper(I)-catalyzed cycloaddition reaction of terminal acetylenes with azides. Similar results were observed for all of the dendrimers employed in this study.

### EXPERIMENTAL

### General Methods

Analytical TLC was performed on commercial Merck Plates coated with silica gel GF254 (0.24 mm thick). Silica Gel for flash chromatography was Merck Kieselgel 60 (230-400 mesh, ASTM). ¹H NMR (400 MHz) and ¹³C NMR (100 MHz) measurements were performed on a Bruker AC 400 spectrometer at room temperature. Size exclusion chromatography (SEC) was carried out at room temperature on a Waters chromatograph connected to a Waters 410 differential refractometer and six Waters Styragel® columns (five HR-5 μm and one HMW-20 μm) using THF as eluant (flow rate: 1 mL/min). A Waters 410 differential refractometer and a 996 photodiode array detector were employed. The molecular weights of the polymers were calculated relative to linear polystyrene standards. Non-aqueous click reactions were performed in sealed tubes using a SmithCreator microwave reactor (Personal Chemistry Inc.). The modulated differential scanning calorimetry (MDSC) measurements were performed with a TA Instruments DSC 2920 and a ramp rate of 4 degrees per minute. The thermal gravimetric analysis measurements were done with a TA Instruments Hi-Res TGA 2950, under nitrogen purge, and the ramp rate was 10 degrees per minute. MALDI-TOF mass spectrometry was performed on a PerSeptive Biosystems Voyager DE mass spectrometer operating in linear mode, using dithranol in combination with silver trifluoroacetate as matrix.

### Materials

[Cu(PPh₃)₃Br], (Gujadhur, R., et al., Tetrahedron Lett. 2001, 42, 4791) [CuP(OEt)₃I], (Ziegler, F. E., et al., Organic Synthesis; Wiley: New York, 1993; Collect. Vol. VIII, pp 586) traditional Frechet-type benzyl ether dendrons 2.32-34, (Hawker, C. J., et al., J. Am. Chem. Soc. 1990, 112, 7638-7645) and N-Succinimidyl 4-pentynoate 2.50, (Salmain, M., et al. Bioconjugate Chem. 1993, 2, 13) were synthesized as described previously. All other reagents were obtained from Aldrich and used as received.

Nomenclature: The nomenclature used for dendritic structures described in this article is as follows: (Acet)ₙ-[G-X]-F for acetylene terminated dendrons, where n indicates the number of chain end acetylene functionalities, X indicates the generation number of the dendritic framework and F describes the functional group at the focal point; either COOMe for methyl ester, OH for hydroxymethyl, and Br for bromomethyl. (Acet)ₙ-([G-X])₃-[C] for acetylene terminated dendrimers, where n indicates the number of peripheral acetylene functionalities, X indicates the generation number of the dendritic framework and [C] the tris(phenolic) core; (Y)ₙ-([G-X])₃-[C] for functionalized dendrimers, where Y describes the external functional group; either Oct for n-octyl, Ad for adamantyl, MeO for 2-(2-methoxyethoxy)ethyl, Hex for 6-hydrohexyl, Est for Methyl 4-(azidomethyl)benzoate, PhS for methyl phenyl sulfide, Sug for 1-(2-azidoethoxy)-(-D-mannopyranodise, Nuc for 3′-deoxythymidine, DR for N-ethyl-N-2′-azidoethyl-4-(2″-chloro-4″-nitrophenylazo)phenylamine (Disperse Red 13), Ant for 9-(methyl)anthracene and [G-X] for benzyl ether terminated dendrons, where X indicates the generation number of the dendritic framework. The external functional groups Y are linked to the dendritic scaffold by a 1,4-disubstituted 1,2,3-triazole ring.

As employed herein, the term “dendrimer” refers to polymers having a regular branched structure of a fractal nature. Dendrimers have a core from which the inner branches emanate. Further branches may emanate from the inner branches and so forth. Distal from the core are the terminal branches, i.e., branches from which no further branches emanate. The periphery is defined as that portion of the dendrimeric polymer attached to the distal branches from which no further branches emanate. The periphery consists of the collection of terminal chains, i.e., that portion of the dendrimeric polymer distal from the terminal branches and ending with the chain ends. As an inherent consequence of their fractal nature, dendrimers have a large number of functional groups at their chain ends. It is the chain ends that interact with the environment of the dendrimer and impart the properties of the dendrimer. The terms “chain end” and “functional group” are somewhat synonymous. However, the term “chain end” emphasizes the physical location of a section of the dendrimer; and the term “functional group” emphasizes the physical properties imparted by the “chain end”. The “functional group” may be any chemical moiety compatible for use as “chain end”.

### Synthesis of Acetylene Terminated Dendrons

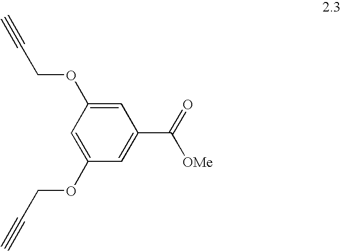

### General Procedure for Alkylation. (Acet)₂-[G-1]-COOMe, 2.3

To a stirred solution of propargyl bromide 2.1 (29.7 g, 220 mmol) and methyl 3,5-dihydroxybenzoate 2.2 (16.8 g, 100 mmol) in acetone (300 mL) were added potassium carbonate (15.1 g, 109 mmol) and 18-crown-6 (0.1 g, 0.4 mmol). The reaction mixture was heated at reflux under nitrogen for 24 hours, filtered, evaporated to dryness and partitioned between water and dichloromethane. The aqueous layer was then extracted with dichloromethane (2×100 mL) and the combined extracts dried and evaporated to dryness. The crude material was then crystallized in methanol to give the ester 2.3 as pale yellow crystals. Yield: 20.6 g (84.4%). Anal. Calcd. for C₁₄H₁₂O₄: C, 68.8; H, 4.95. Found: C, 69.0; H, 4.89. M.p. 105-106° C.

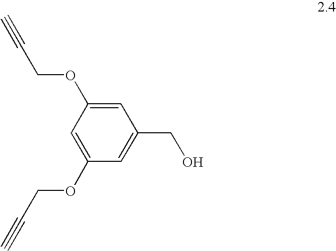

### General Procedure for Reduction. (Acet)₂-[G-1]-OH, 2.4

To a stirred solution of the ester 2.3 (20.6 g, 84.4 mmol) in anhydrous THF (170 mL) was added lithium aluminum hydride (3.99 g, 105 mmol) in small portions and the reaction mixture was stirred at room temperature for 2 hours. Beckstrom's reagent (20 g) was then added to quench the remaining lithium aluminum hydride. The reaction mixture was filtered under vacuum, the solid was rinsed with dichloromethane and the filtrate dried with MgSO₄. After evaporation of the solvents, the alcohol 2.4 was purified by recrystallization from methanol and recovered as white crystals. Yield: 16.4 g (90.1%). Anal. Calcd. for C₁₃H₁₂O₃: C, 72.2; H, 5.59. Found: C, 72.1; H, 5.73. M.p. 66-67° C.

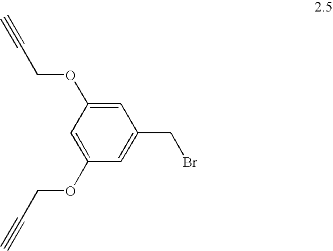

### General Procedure for Bromination. (Acet)₂-[G-1]-Br, 2.5

To a stirred solution of the alcohol 2.4 (14.7 g, 68.0 mmol) in tetrahydrofuran (200 mL) was added carbon tetrabromide (28.2 g, 85.0 mmol) followed by the portion-wise addition of triphenylphosphine (22.3 g, 85.0 mmol). The reaction was stirred at room temperature for 5 minutes and then quenched with 50 mL of water. Tetrahydrofuran was evaporated and the crude product was extracted with dichloromethane (2×150 mL). The organic layer was dried with MgSO₄ and evaporated to dryness. The crude product was purified by column chromatography eluting with a 1:1 mixture of hexane and dichloromethane. After evaporation of the solvents, the bromide 2.5 was recovered as a colorless solid. Yield: 23.4 g (94.8%). Anal. Calcd. for C₁₃H₁₁BrO₂: C, 55.9; H, 3.97. Found: C, 55.7; H, 4.04. M.p. 64-65° C.

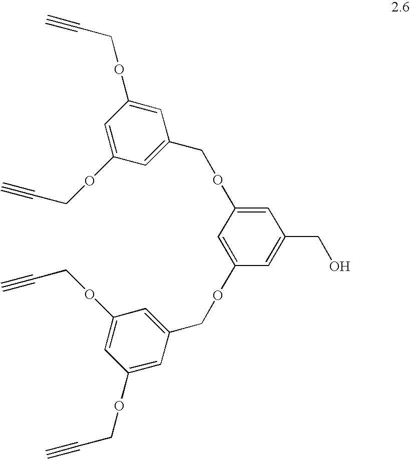

### (Acet)₄-[G-2]-OH, 2.6

This compound was prepared from 3,5-dihydroxybenzyl alcohol 2.7 and 2.2 equivalents of the bromide 2.5, according to the general procedure for alkylation with potassium carbonate and 18-crown-6 in acetone. The crude product was purified by column chromatography eluting with a 19:1 mixture of dichloromethane and diethyl ether, to give the alcohol 2.6 as a colorless solid. Yield: 2.1 g (83.4%). Anal. Calcd. for C₃₃H₂₈O₇: C, 73.9; H, 5.26. Found: C, 74.2; H, 4.98. M.p. 64-65° C.

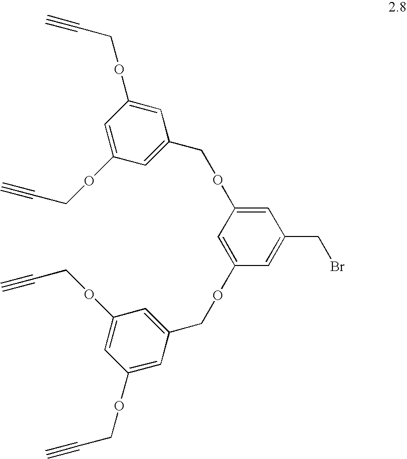

### (Acet)₄-[G-2]-Br, 2.8

This compound was prepared from the alcohol 2.6 according to the general procedure for bromination with carbon tetrabromide and triphenylphosphine in tetrahydrofuran. The crude product was purified by column chromatography eluting with dichloromethane to give the bromide 2.8 as a colorless solid. Yield: 2.0 g (89.7%). Anal. Calcd. for C₃₃H₂₇BrO₆: C, 66.1; H, 4.54. Found: C, 66.3; H, 4.45. m.p. 68-69° C.

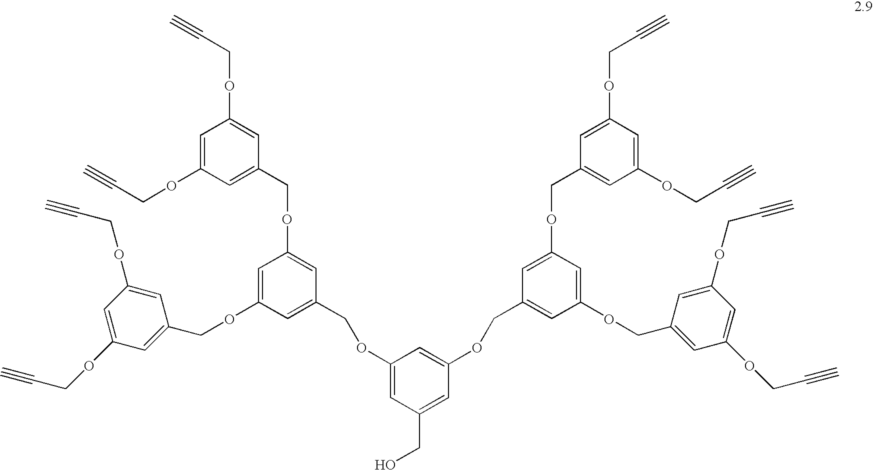

### (Acet)₈-[G-3]-OH, 2.9

This compound was prepared from 3,5-dihydroxybenzyl alcohol 2.7 and 2.2 equivalent of the bromide 2.8, according to the general procedure for alkylation with potassium carbonate and 18-crown-6 in acetone. The crude product was purified by column chromatography eluting with a 19:1 mixture of dichloromethane and diethyl ether, to give the alcohol 2.9 as a colorless glass. Yield: 1.5 g (90.3%). MALDI MS: Calcd. for C₇₃H₆₀O₁₅: 1176. Found: 1177 (MH⁺). T_{g}=13° C.

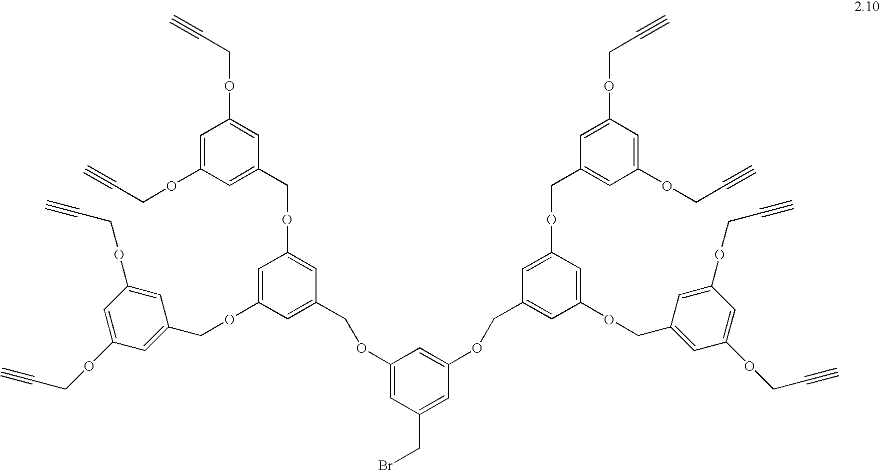

### (Acet)₈-[G-3]-Br, 2.10

This compound was prepared from the alcohol, 2.9, according to the general procedure for bromination with carbon tetrabromide and triphenylphosphine in tetrahydrofuran. The crude product was purified by column chromatography eluting with dichloromethane to give the bromide 2.10 as a colorless glass. Yield: 1.4 g (90.5%). MALDI MS: Calcd. for C₇₃H₅₉BrO₁₄: 1238. Found: 1239 (MH⁺). T_{g}=12° C.

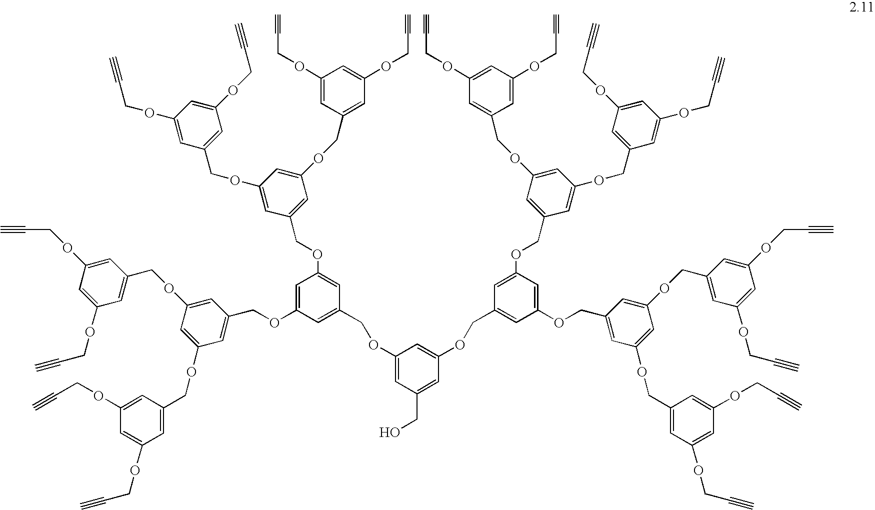

### (Acet)₁₆-[G-4]-OH, 2.11

This compound was prepared from the alcohol 2.7 and 2.2 equivalent of the bromide 2.10, according to the general procedure for alkylation with potassium carbonate and 18-crown-6 in acetone. The crude product was purified by column chromatography eluting with 9:1 mixture of dichloromethane and diethyl ether, to give 2.11 as a colorless glass. Yield: 1.3 g (85.1%). MALDI MS: Calcd. for C₁₅₃H₁₂₄O₃₁: 2456.8. Found: 2458 (MH⁺). T_{g}=17° C.

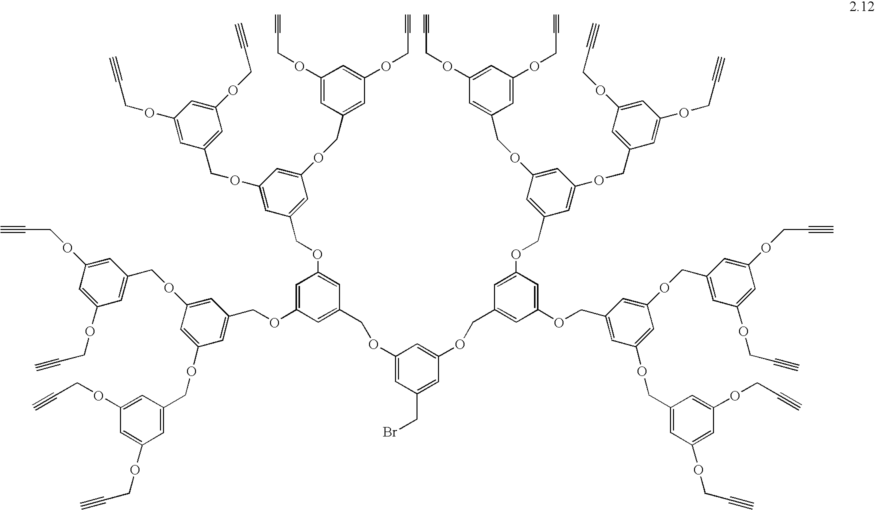

### (Acet)₁₆-[G-4]-Br, 2.12

This compound was prepared from the alcohol 2.11, according to the general procedure for bromination with carbon tetrabromide and triphenylphosphine in tetrahydrofuran. The crude product was purified by column chromatography eluting with a 9:1 mixture of dichloromethane and hexane, to give the bromide 2.12 as a colorless glass. Yield: 1.92 g (98.7%). MALDI MS Calcd. for C₁₅₃H₁₂₃BrO₃₀: 2518.7. Found: 2520 (MH⁺). T_{g}=18° C.

### Synthesis of Acetylene Terminated Dendrimers with Tris(phenolic) Core (Acet)₃-([G-0])₃-[C], 2.14

This compound was prepared from 1,1,1-tris(4-hydroxyphenyl)ethane 2.13 and 3.3 equivalents of propargyl bromide 2.1, according to the general procedure for alkylation with potassium carbonate and 18-crown-6 in acetone. The crude product was purified by column chromatography eluting with a 19:1 mixture of dichloromethane and methanol, to give 2.14 as colorless oil. Yield: 1.2 g (72.2%). Anal. Calcd. for C₂₉H₂₄O₃: C, 82.8; H, 5.75. Found: C, 82.6; H, 5.65.

### (Acet)₆-([G-1])₃-[C], 2.15

This compound was prepared from 1,1,1-tris(4-hydroxyphenyl)ethane 2.13 and 3.3 equivalents of the bromide 2.5, according to the general procedure for alkylation with potassium carbonate and 18-crown-6 in acetone. The crude product was purified by column chromatography eluting with a 9:1 mixture of dichloromethane and hexane, to give 2.15 as a pale yellow oil. Yield: 1.5 g (58.4%). Anal. Calcd. for C₅₇H₄₈O₉: C, 78.1; H, 5.52. Found: C, 77.9; H, 5.47. T_{g}=10° C.

### (Acet)₁₂-([G-2])₃-[C], 2.16

This compound was prepared from 1,1,1-tris(4-hydroxyphenyl)ethane 2.13 and 3.3 equivalents of the bromide 2.8, according to the general procedure for alkylation with potassium carbonate and 18-crown-6 in acetone. The crude product was purified by column chromatography eluting with a 19:1 mixture of dichloromethane and diethyl ether, to give 2.16 as a colorless gum. Yield: 1.46 g (58.9%). Anal. Calcd. for C₁₁₇H₉₆O₂₁: C, 76.5; H, 5.26. Found: C, 76.7; H, 5.42. T_{g}=13° C.

### (Acet)₂₄-([G-3])₃-[C], 2.17

This compound was prepared from 1,1,1-tris(4-hydroxyphenyl)ethane 2.13 and 3.3 equivalents of the bromide 2.10, according to the general procedure for alkylation with potassium carbonate and 18-crown-6 in acetone. The crude product was purified by column chromatography eluting with 49:1 mixture of dichloromethane and diethyl ether, to give 2.17 as a colorless gum. Yield: 1.56 g (89.7%). Anal. Calcd. for C₂₃₇H₁₉₂O₄₅: C, 75.7; H, 5.14. Found: C, 75.8; H, 5.23. T_{g}=17° C.

### (Acet)₄₈-([G-4])₃-[C], 2.18

This compound was prepared from 1,1,1-tris(4-hydroxyphenyl)ethane 2.13 and 3.3 equivalents of the bromide 2.12, according to the general procedure for alkylation with potassium carbonate and 18-crown-6 in acetone. The crude product was purified by column chromatography eluting with a 19:1 mixture of dichloromethane and diethyl ether, to give 2.18 as a colorless glass. Yield: 1.67 g (75.2%). Anal. Calcd. for C₄₇₇H₃₈₄O₉₃: C, 75.3; H, 5.09. Found: C, 75.5; H, 4.87. T_{g}=21° C.

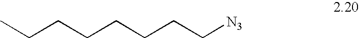

### General Procedure for Preparation of Azide Derivatives by Nucleophilic Displacement. n-Octyl azide, 2.20

A solution of n-octyl bromide (13.1 g, 67.8 mmol) and sodium azide (13.2 g, 203 mmol) in water (150 mL) was stirred under reflux for 16 hours, at which time GC analysis indicated the complete consumption of the bromide. The aqueous phase was extracted with ethyl acetate (2×200 mL), dried with MgSO₄ and evaporated to dryness, to give 2.20 as colorless oil. Yield: 9.67 g (95.7%). Anal. Calcd. for C₈H₁₇N₃: C, 61.9; H, 11.0; N, 27.1. Found: C, 62.2; H, 10.8; N, 26.9.

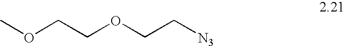

### 1-Azido-2-(2-methoxyethoxy)ethane, 2.21

This compound was prepared from 1-bromo-2-(2-methoxyethoxy)ethane, according to the general procedure with sodium azide in water, to give 2.21 as a colorless oil. Yield: 2 g (87.3%). Anal. Calcd. for C₅H₁₁N₃O₂: C, 39.6; H, 7.64; N, 28.9. Found: C, 39.9; H, 7.38; N, 28.9.

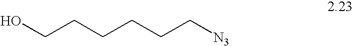

### 6-Azido-1-hexanol, 2.23

This compound was prepared from 6-chloro-1-hexanol according to the general procedure with sodium azide in water, to give 2.23 as a colorless oil. Yield: 2.2 g (96.7%). EI MS.; Calcd. for C₆H₁₃N₃O: 143.1057. Found: 143.1061.

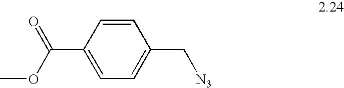

### Methyl 4-(azidomethyl)benzoate, 2.24

This compound was prepared from methyl 4-(bromomethyl)benzoate according to the general procedure with sodium azide in water, to give 2.24 as a colorless solid. Yield: 1.7 g (96.3%). Anal. Calcd. for C₉H₉N₃O₂: C, 56.5; H, 4.74; N, 22.0. Found: C, 56.4; H, 4.92; N, 21.8.

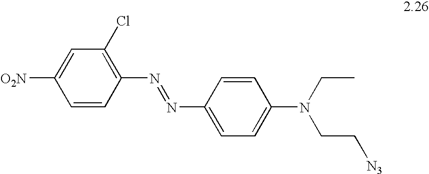

### N-ethyl-N-2′-azidoethyl-4-(2″-chloro-4″-nitrophenylazo)phenylamine, 2.26

Methanesulfonyl chloride (98.0 mg, 0.860 mmol) was added dropwise to a solution of Disperse Red 13 (200 mg, 0.573 mmol) and triethylamine (87.0 mg, 0.860 mmol) in 10 mL of dichloromethane. The mixture was allowed to stir at room temperature under nitrogen for 12 hours, the formed solids filtered and the organic phase diluted with dichloromethane (100 mL) and extracted with H₂O (3×25 mL). After drying over MgSO₄ and evaporation to dryness, the crude mesylate was redissolved in DMSO (10 mL) and sodium azide (245 mg, 0.573 mmol) was added. The reaction mixture was then stirred at 50° C. for 16 hours, filtered, concentrated under reduced pressure and purified by column chromatography eluting with a 1:9 mixture of ethyl acetate and hexane gradually increasing to 3:7 ethyl acetate and hexane. This gave the azido derivative 2.26 as a red solid. Yield: 199 mg (93.0%). Anal. Calcd. for C₁₆H₁₆ClN₇O₂: C, 51.4; H, 4.31; N, 26.2. Found: C, 51.4; H, 4.52; N, 26.0. M.p. 74-75° C.

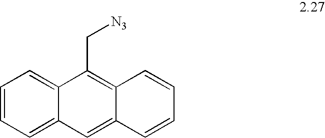

### 9-(azidomethyl)anthracene, 2.27

This compound was prepared from 10-(chloromethyl)anthracene according to the general procedure for azidation with sodium azide using N,N-dimethylformamide instead of water, to give 2.27 as a yellow solid. Yield: 2.6 g (90.3%). Anal. Calcd. for C₁₅H₁₁N₃: C, 77.23; H, 4.75; N, 18.01. Found: C, 77.43; H, 4.81; N, 17.67. M.p. 144-145° C.

### [G-1]-N₃, 2.29

This compound was prepared from [G-1]-Br 2.32, according to the general procedure with sodium azide using dimethyl sulfoxide instead of water, to give 2.29 as a white solid. Yield: 1.87 g (98.2%). Anal. Calcd. for C₂₁H₁₉N₃O₂: C, 73.0; H, 5.54; N, 12.2. Found: C, 72.9; H, 5.71; N, 12.0. M.p. 110-112° C.

### [G-2]-N₃, 2.30

This compound was prepared from [G-2]-Br 2.33, according to the general procedure with sodium azide in dimethyl sulfoxide, to give 2.30 as a white solid, Yield: 2.1 g (97.9%). Anal. Calcd. for C₄₉H₄₃N₃O₆: C, 76.4; H, 5.63; N, 5.46. Found: C, 76.2; H, 5.48; N, 5.71. M.p. 84-85° C.

### [G-3]-N₃, 2.31

This compound was prepared from [G-3]-Br 2.34, according to the general procedure with sodium azide in dimethyl sulfoxide, to give 2.31 as a colorless glass. Yield: 1.98 g (96.1%). T_{g}=41° C.

### Functionalization of Acetylene Terminated Tris(Phenolic) Cored Dendrimers General Procedure for the Triazole Coupling Catalyzed by [CuP(OEt)₃I]. (MeO)₃-[G-0]₃-[C], 2.35

A solution of the acetylene terminated dendrimer 2.14 (1.35 g, 4.33 mmol), azide 2.21 (2.35 g, 16.2 mmol), N,N-diisopropylethylamine (0.58 g, 4.50 mmol) and [CuP(OEt)₃I] (0.11 g, 0.30 mmol) in tetrahydrofuran (20 mL), was either submitted to microwave irradiation at a nominal temperature of 140° C. for 20 minutes or stirred at room temperature for ca. 48 h. The crude product was purified by column chromatography eluting with a 19:1 mixture of dichloromethane and methanol, to give 2.35 as a pale yellow gum. Yield: 1.34 g (72.2%). EI MS: 857 (MH⁺). T_{g}=13° C.

### General Procedure for the Triazole Coupling Catalyzed by [Cu(PPh₃)₃Br]. (Oct)₆-[G-1]₃-[C], 2.36

A solution of the acetylene terminated dendrimer 2.15 (1.11 g, 1.23 mmol), n-octyl azide 2.20 (1.43 g, 7.45 mmol), N,N-diisopropylethylamine (0.48 g, 3.7 mmol) and [Cu(PPh₃)₃Br] (0.11 g, 0.25 mmol) in tetrahydrofuran (20 mL). The reaction mixture was then placed in a sealed vial and was then either subjected to microwave irradiation at a nominal temperature of 140° C. for 20 minutes or stirred at room temperature for ca. 48 h. The crude product was purified by column chromatography eluting with a 9:1 mixture of dichloromethane and methanol, to give 2.36 as a colorless oil. Yield: 1.32 g (92.7%). MALDI-TOF MS. Calcd. for C₁₀₅H₁₅₀N₁₈O₉: 1807. Found: 1820 (MNa⁺). T_{g}=7° C.

### (Ad)₆-[G-1]₃-[C], 2.37

This compound was prepared from the acetylene terminated dendrimer 2.15 and 1-azidoadamantane 2.19, according to the general procedure for click reaction with N,N-diisopropylethylamine and [Cu(PPh₃)₃Br] in tetrahydrofuran under microwave irradiation. The crude product was purified by column chromatography eluting with a 1:1 mixture of dichloromethane and hexane, to give 2.37 as a white solid. Yield: 1.36 g (95.6%). Anal. Calcd. for C₁₁₇H₁₃₈N₁₈O₉: C, 72.4; H, 7.17; N, 13.0. Found: C, 72.2; H, 6.98; N, 13.3. T_{g}=121° C.

### (Hex)₆-[G-1]₃-[C], 2.38

This compound was prepared from the acetylene terminated dendrimer 2.15 and the azide 2.23, according to the general procedure for click reaction with N,N-diisopropylethylamine and [Cu(PPh₃)₃Br] in tetrahydrofuran under microwave irradiation. The crude product was purified by column chromatography eluting with a 2:1 mixture of dichloromethane and hexane, to give 2.38 as a orange viscous oil. Yield: 1.54 g (92.6%). Anal. Calcd. for C₉₅H₁₂₆N₁₈O₁₅: C, 65.8; H, 7.02; N, 13.9. Found: C, 65.9; H, 6.94; N, 13.7. T_{g}=9° C.

### (Ad)₁₂-[G-2]₃-[C], 2.39

This compound was prepared from the acetylene terminated dendrimer 2.16 and 1-azidoadamantane 2.19, according to the general procedure for click reaction with N,N-diisopropylethylamine and [Cu(PPh₃)₃Br] in tetrahydrofuran under microwave irradiation. The crude product was purified by column chromatography eluting with a 9:1 mixture of dichloromethane and methanol, to give 2.39 as a pale yellow powder. Yield: 1.25 g (86.6%). MALDI MS. Calcd. for C₂₃₇H₂₇₆N₃₆O₂₁: 3962. Found: 3963 (MH⁺). T_{g}=119° C.

### (DR)₁₂-[G-2]₃-[C], 2.40

This compound was prepared from the acetylene terminated dendrimer 2.16 and the azide 2.26, according to the general procedure for click reaction with N,N-diisopropylethylamine and [Cu(PPh₃)₃Br] in tetrahydrofuran under microwave irradiation. The crude product was purified by column chromatography eluting with a 7:3 mixture of hexane and ethyl acetate, to give 2.40 as a red viscous oil. Yield: 1.35 g (89.7%). MALDI MS. Calcd. for C₃₀₉H₂₈₈Cl₁₂N₈₄O₄₅: 6313.9. Found: 6315 (MH⁺). T_{g}=119° C.

### General Procedure for the Click Reaction Catalyzed by CuSO₄ in Water. (Nuc)₁₂-[G-2]₃-[C], 2.41

A solution of the acetylene terminated dendrimer 2.16 (18 mg, 10 μmol), 3′-azido-3′-deoxythymidine 2.28 (32 mg, 0.12 mmol), sodium ascorbate (2 mg, 12 μmol) and CuSO₄ (1 mg, 6 μmol) in a 1:1 mixture of water and tetrahydrofuran (2 mL) was stirred at room temperature for ca. 48 h. After evaporation of the solvents, the crude product was purified by column chromatography eluting with a 9:1 mixture of dichloromethane and methanol, to give 2.41 as a white powder. Yield: 1.31 g (94.0%). MALDI MS.; Calcd. for C₂₂₅H₂₂₈N₆₀O₆₉: 4873.6. Found: 4875 (MH⁺). T_{g}=17° C.

### (Ad)₂₄-[G-3]₃-[C], 5.42

This compound was prepared from the acetylene terminated dendrimer 5.17 and 1-azidoadamantane 5.19, according to the general procedure for click reaction with N,N-diisopropylethylamine and Cu(PPh₃)₃Br in tetrahydrofuran under microwave irradiation. The crude product was purified by column chromatography eluting with a 9:1 mixture of dichloromethane and methanol, to give 5.42 as a colorless powder. Yield: 1.25 g (96.1%). MALDI mass spec.; Calcd. for C₄₃₇H₅₅₂N₇₂O₄₅: 7528.3. Found: 7551 (MNa⁺). T_{g}=108° C.

### (Est)₂₄-[G-3]₃-[C], 5.43

This compound was prepared from the acetylene terminated dendrimer 5.17 and the azide 5.24, according to the general procedure for click reaction with N,N-diisopropylethylamine and [Cu(PPh₃)₃Br] in tetrahydrofuran under microwave irradiation. The crude product was precipitated in diethyl ether, to give 44 as a white powder. Yield: 1.42 g (93.6%). MALDI mass spec.; Calcd. for C₄₅₃H₄₀₈N₇₂O₉₃: 8342.9. Found: 8344 (MH⁺). T_{g}=72° C.

### (PhS)₂₄-[G-3]₃-[C], 5.44

This compound was prepared from the acetylene terminated dendrimer 5.17 and azidomethylphenylsulfide 5.22, according to the general procedure for click reaction with N,N-diisopropylethylamine and [Cu(PPh₃)₃Br] in tetrahydrofuran under microwave irradiation. The crude product was precipitated in diethyl ether, to give 5.44 as a colorless powder. Yield: 1.45 g (92.9%). MALDI MS Calcd. for C₄₀₅H₃₆₀N₇₂O₄₅S₂₄: 7718. Found: 7719 (MH⁺). T_{g}=63° C.

### [G-1]₂₄-[G-3]₃-[C], 2.45

This compound was prepared from the acetylene terminated dendrimer 2.17 and [G-1]-N₃ 2.29, according to the general procedure for click reaction with N,N-diisopropylethylamine and [Cu(PPh₃)₃Br] in tetrahydrofuran under microwave irradiation. The crude product was purified by column chromatography eluting with a 19:1 mixture of dichloromethane and methanol, to give 2.45 as a pale yellow glass, Yield: 1.65 g (81.8%). T_{g}=74° C.

### (Ad)₄₈-[G-4]₃-[C], 2.46

This compound was prepared from the acetylene terminated dendrimer 2.18 and 1-azidoadamantane 2.19, according to the general procedure for click reaction with N,N-diisopropylethylamine and [Cu(PPh₃)₃Br] in tetrahydrofuran under microwave irradiation. The crude product was purified by column chromatography eluting with a 19:1 mixture of dichloromethane and methanol, to give 2.46 as a white solid. Yield: 1.41 g (96.8%). T_{g}=97° C.

### (Hex)₄₈-[G-4]₃-[C], 2.47

This compound was prepared from the acetylene terminated dendrimer 2.18 and the azide 2.23, according to the general procedure for click reaction with N,N-diisopropylethylamine and [Cu(PPh₃)₃Br] in tetrahydrofuran under microwave irradiation. The crude product was precipitated in diethyl ether, to give 2.47 as a pale yellow glass. Yield: 1.34 g (94%). T_{g}=41° C.

### [G-2]₄₈-[G-4]₃-[C], 2.48

This compound was prepared from the acetylene terminated dendrimer 2.18 and [G-2]-N₃ 2.30, according to the general procedure for click reaction with N,N-diisopropylethylamine and [Cu(PPh₃)₃Br] in tetrahydrofuran under microwave irradiation. The crude product was purified by column chromatography eluting with a 19:1 mixture of dichloromethane and methanol, to give 2.49 as a pale yellow glass, Yield: 1.46 g (95.1%). T_{g}=70° C.

### [G-3]₄₈-[G-4]₃-[C], 2.49

This compound was prepared from the acetylene terminated dendrimer 2.18 and [G-3]-N₃ 2.31, according to the general procedure for click reaction with N,N-diisopropylethylamine and Cu(PPh₃)₃Br in tetrahydrofuran under microwave irradiation. The crude product was purified by column chromatography eluting with a 9:1 mixture of dichloromethane and methanol, to give 2.49 as a colorless foam. Yield: 1.24 g (75.7%). T_{g}=64° C.

### General Procedure for Chemical Modification of Amino-Terminated Polyamine and Polyamide Dendrimers. (MeO)₈-[G-1]-PAMAM, 5.51

A solution of N-Succinimidyl 4-pentynoate 2.50 (0.68 g, 3.5 mmol)¹⁴ in 10 mL of dry tetrahydrofuran was added dropwise to a solution of [G-1]-PAMAM (2.5 g, 20% in MeOH, 2.8 mmol of amine functionality) in 10 mL of dry tetrahydrofuran. After heating to reflux during 2 hours, the mixture was cooled and a solution of the azide 2.21 (0.97 g, 7.0 mmol), N,N-diisopropylethylamine (1.36 g, 10.5 mmol) and [Cu(PPh₃)₃Br] (0.7 g, 0.7 mmol) in 10 mL of dry tetrahydrofuran was added and stirring continued at room temperature for 48 hours. The reaction mixture was then concentrated, filtered and precipitated sequentially in ethyl acetate and in diethyl ether to give 2.51 as a slightly orange viscous oil (850 mg, 81.5%).

### (MeO)₃₂-[G-4]-DSM, 2.52

This compound was prepared from [G-4]-DAB-Am-32, N-Succinimidyl 4-pentynoate 2.50 (1.25 equivalent)¹⁴ in tetrahydrofuran, and subsequent functionalization by click chemistry with the azide 2.21 (2 equivalents), N,N-diisopropylethylamine (3 equivalents) and [Cu(PPh₃)₃Br] (0.2 equivalents) in tetrahydrofuran at room temperature during 48 hours. The crude product was purified by successive precipitation in ethyl acetate and in diethyl ether to give 2.52 as a slightly yellow viscous oil. Yield: 1.34 g (77.5%).

### General Procedure for the Synthesis of Acetylene Terminated Hyperbranched Polyesters (Boltorn). Anhydride Activated Pentyonic Acid Acetylene, 2.53

To a stirred solution of pentynoic carboxylic acid (2.00 g, 20.4 mmol) in dichloromethane (20 mL) was added 1,3-dicyclohexylcarbodiimide (2.10 g, 1.02 mmol). The reaction mixture was stirred at room temperature for 16 hours, filtered and evaporated to dryness. The byproducts were then isolated through precipitation in 20 mL of hexane and filtration. After evaporation of the solvent, the anhydride 2.53 was recovered as a colorless oil (1.72 g, 95.0%).

### Acetylene Terminated Boltorn-H40. (Acet)₆₄-[G-4]₄, 2.54

A solution of Boltorn H40 (0.370 g, 50.6 (mol), dimethylaminopyridine (98.8 mg, 0.809 mmol) and pyridine (1.28, 16.2 mmol) in 10 mL of dichloromethane was added to the anhydride 2.53 (0.939 g, 5.27 mmol). The reaction was stirred for 16 hours and then all excess anhydride was converted to the acid analogue by quenching with water. The mixture was then diluted with 200 mL of dichloromethane and extracted with Na₂CO₃ (2×25 mL, 10% w/v) and NaHSO₄ (2×25 mL, 10% w/v). The organic phase was dried, filtered and concentrated. To the oily residual was added a small amount of diethyl ether and the solids (byproduct) were filtered. Finally, the acetylene functionalized polyester 2.54 was collected as a colorless viscous oil. Yield: 0.465 g (73.8%) after precipitation from ether into hexane.

### Functionalization of Acetylene Terminated Hyperbranched Polyester, Boltorn H40. (Ant)₆₄-[G-4]₄, 2.55.

A solution of the acetylene terminated hyperbranched polyester 5.54 (100 mg, 8.04 (mol), azide 5.27 (240 mg, 1.03 mmol), N,N-diisopropylethylamine (133 mg, 1.03 mmol) and [Cu(PPh₃)₃Br] (48.9 mg, 51.5 (mol) in tetrahydrofuran (5 mL) was sealed in a vial and submitted to microwave irradiation at 100° C. for 10 minutes. The crude product was concentrated and precipitated 3 times in diethyl ether to give 2.55 as a pale yellow solid (165 mg, 75.0% yield).

### Acetylene-Terminated Bis-MPA Dendrimer. (Acet)₁₂-[G-2]₃-[C], 2.56

The dodecahydroxy-terminated dendrimer (1.20 g, 0.885 mmol) was dissolved in pyridine (4.15 mL) followed by the addition of CH₂Cl₂ (4 mL), DMAP (197 mg, 1.59 mmol), and 4-pentynoic anhydride (2.27 g, 12.7 mmol). The reaction mixture was stirred at room temperature overnight, and the crude reaction mixture was diluted in CH₂Cl₂ (150 mL) and washed with 10% NaHSO₄ (3×80 mL), saturated NaHCO₃ (2×50 mL), and brine (50 mL). The organic phase was dried over MgSO₄, filtered, concentrated, and purified by liquid column chromatography on silica gel, eluting with hexane and gradually increasing the polarity to 45:55 EtOAc:hexane to give 2.57 as a colorless viscous oil. Yield 1.94 g (90%). MALDI MS: Calcd for C125H138O42: 2311.86. Found: 2313 (MH⁺).

### (SUg)₁₂-[G-2]₃-[C], 2.57

This dendrimer was prepared according to the general procedure for click reaction with N,N-diisopropylethylamine and [Cu(PPh₃)₃Br] in tetrahydrofuran. Yield: 1.02 g (92%). MALDI MS Calcd for C₂₉₃H₄₁₄O₁₁₄N₃₆: 6264. Found: 6265 (MH⁺).

### DETAILED DESCRIPTION OF DRAWINGS

FIG. 1 illustrates a scheme showing the synthesis of successive generations of dendrons based on the well known 3,5-dioxybenzyl ether 2.7. A traditional convergent growth approach was applied with the respective dendrons from generation 1 to 4 being obtained in excellent yields.

FIGS. 2a, 2b and 2c illustrate a scheme where the coupling of the dendrons to a trifunctional core 2.13 gives the desired dendrimers 2.15-2.18 and propargylation of the core 2.13 gives the compound 2.14. Compounds 2.14-2.18 have 3, 6, 12, 24 and 48 terminal acetylene groups, respectively. These acetylene terminated dendrimers were characterized by standard techniques and had physical properties similar to the extensively studied, benzyl ether terminated, Fréchet type dendrimers (Hawker, C. J.; Fréchet, J. M. J. J. Am. Chem. Soc. 1990, 112, 7638-7645; Harth, E. M.; Hecht, S.; Helms, B.; Malmström, E. E.; Fréchet, J. M. J.; Hawker, C. J. J. Am. Chem. Soc. 2002, 124, 3926-3938).

FIG. 3 illustrates a proton NMR spectrum for the fourth generation dendrimer (Acet)₄₈-([G-4])₃-[C], 2.18. The unique resonances for the terminal propargyl units were readily observed in the ¹H NMR spectra of 2.14-2.18 with the acetylene proton appearing as a triplet at ca. 2.50 ppm and the propargyl-CH₂ as a sharp doublet at ca. 4.60 ppm. These unique resonances can be seen for the 4^{th} generation dendrimer, 2.18, which also shows the classical resonances for the internal 3,5-dioxybenzyl ether repeat units (4.90 and 6.4-6.7 ppm) and the trifunctional core (2.05 and 6.80-7.00 ppm).

FIG. 4 illustrates a scheme showing the functionalization of the commercially available, hyperbranched polyester based on 2,2-bis(hydroxymethyl)propionic acid (bis MPA) (Boltorn) with pent-4-ynoyl anhydride, 2.53. The functionalized ester was obtained in quantitative yield. Note that the starting dendrimer has unreacted hydroxyl groups after the 1^{st} generation.

FIG. 5 illustrates a reaction showing the functionalization of the hexaacetylene-terminated polyether dendrimer, 2.15, with a simple azido-derivative, 1-azidoadamantane 2.19. Under standard conditions, CuSO₄/sodium ascorbate in aqueous solution, no reaction was observed due to the insolubility of the starting materials in the reaction mixture. As demonstrated previously (Wu, P.; Feldman, A. K.; Nugent, A. K.; Hawker, C. J.; Scheel, A.; Voit, B.; Pyun, J.; Fréchet, J. M. J.; Sharpless, K. B.; Fokin, V. V. Angew. Chem., Int Ed. 2004, 43, 3928-3932), this incompatibility with aqueous reaction conditions can be overcome by employing an organosoluble catalyst, [Cu(PPh₃)₃Br] or [(EtO₃)PCuI]. Reaction of the hexa-functionalized dendrimer, 2.15, with 9.0 equivalents of 2.19 in the presence of [(EtO)₃PCuI] under microwave irradiation for 10 minutes (Balderas, F. P.; Munoz, M. O.; et al. Org. Lett. 2003, 5, 1951-1954) was found to give the desired hexa-adamantyl derivative, 2.37, in 72% yield after purification. This result was significantly improved when the CuI catalyst was replaced with [Cu(PPh₃)₃Br]. In this case only a stoichiometric amount (6.0 equivalents) of azide was required to drive the reaction to completion and afford a 95+% yield of 2.37 after purification.

FIG. 6 illustrates a GPC trace showing a clean transition to a higher molecular weight product, 2.37, is observed with no detectable amount of starting dendrimer, 2.15, though under these forcing conditions, a small amount (<2%) of higher molecular weight product was observed at longer reaction times. This is presumably due to Cu-catalyzed coupling of terminal acetylene groups and it was found that decreasing the reaction time, using a slight excess of azide (1.02 equivalents per chain end) while working under more dilute conditions eliminated this minor side reaction. ¹H NMR spectroscopy of the crude dendrimer 2.37 obtained under these reaction conditions showed no resonances for unreacted terminal acetylenic groups, while MALDI-TOF mass spectral analysis showed a single molecular ion for the fully hexa-functionalized derivative, 2.37.

FIG. 7 illustrates the structures of some highly functionalized azides for reaction with acetylene-terminated dendrimers. A wide selection of different structures incorporating reactive functional groups such as the nucleoside, 2.28, or the protected sugar, 2.25, dye molecules such as the Disperse Red azo derivative, 2.26, and even large dendrons, 2.29-2.31, were examined in order to show the compatibility of click chemistry with numerous functional groups.

FIGS. 8a and 8b illustrate tables showing the purified yields obtained for the preparation of chain end functionalized dendrimers from a variety of different azido derivatives, 2.19-2.31, and dendritic core. The purified yields of the copper chemistry were generally over 85-90%. Slightly lower yields were obtained in a small number of cases, however these more represent difficulties in the isolation and purification steps than incomplete reactions. The high efficiency of the methodology is perhaps best exemplified by the functionalization of the 3^{rd} generation dendrimer, 2.17, which contains 24 terminal acetylene groups with methyl 4-(azidomethyl)benzoate, 2.23. Microwave irradiation of a 1:25 mixture of 2.17 and 2.23 for 10 minutes was found to give, after purification by simple precipitation, a 94% yield of the fully functionalized dendrimer, 2.43.

FIG. 9 illustrates a reaction showing the functionalization of the 3^{rd} generation dendrimer, 2.17, which contains 24 terminal acetylene groups with methyl 4-(azidomethyl)benzoate, 2.23. Microwave irradiation of a 1:25 mixture of 2.17 and 2.23 for 10 minutes was found to give, after purification by simple precipitation, a 94% yield of the fully functionalized dendrimer, 2.43. Characterization of 2.43 by a combination of spectroscopic and chromatographic techniques demonstrated the efficiency of the functionalization chemistry. Mass spectrometry showed a predominant molecular ion corresponding to complete substitution of the 24 peripheral acetylene groups, 2.43, (>97%) with only a very minor molecular ion (<3%) corresponding to a single unreacted acetylene group and no detectable ions for products with lower degrees of substitution.

FIG. 10 illustrates a proton NMR of 2.43. The ¹H NMR spectrum of 2.43 shows no detectable resonances for unreacted acetylene groups and unique resonances for the triazole rings (8.24 ppm), methyl benzoate groups (3.35 ppm) and dendritic core could be identified.

FIG. 11 illustrates the reaction of the dodeca-acetylene polyether dendritic core, 2.16, with 3′-azido-3′-deoxythymidine, 2.28, to give the nucleoside-terminated dendrimer, 2.41, in 94% yield. Significantly, no protection of the nucleoside, 2.28, was required and the reaction proceeded at room temperature in aqueous solution.

FIG. 12 illustrates a sequential series of reactions leading to the synthesis of 2.52. Initial acylation with the active ester of pent-4-ynoic acid, 2.50, followed by triazole functionalization with the azido derivative of methoxy(diethylene glycol), 2.21, gives the functionalized DAB dendrimer, 2.52, in an overall yield of 78%.

FIG. 13 illustrates a typical MALDI spectrum for an acetylene-terminated starting material for the dodecafunctionalized bis-MPA dendritic polyester, 2.56, and shows a single set of molecular ions at 2312 (2335 MNa⁺, 2351 MK⁺, and 2374 MCu⁺). The monodisperse nature of the dendritic starting materials permitted MALDI mass spectrometry to be used for detecting very low levels of incomplete functionalization of the chain end.

FIG. 14 illustrates a MALDI spectrum after triazole functionalization with azido mannose derivative, 2.25, in THF. The crude reaction mixture reveals that the peaks for the starting material are cleanly transformed to a single set of molecular ions at 6261 (6265 MH⁺ and 6323 MCu⁺) which is compound 2.57.

What is claimed is:

1. A process for functionalizing a dendrimer having a periphery with multiple chain ends, said process comprising the step of attaching a functional group to all chain ends by means of a click chemistry reaction to form a functionalized dendrimer.

2. A process according to claim 1 wherein the click chemistry reaction is a copper(I)-catalyzed 1,3-dipolar cycloaddition of a terminal acetylene with an azide to form a [1,2,3]-triazole.

3. A process according to claim 1 wherein the multiple chain ends each have a terminal acetylene.

4. A process according to claim 1 wherein the multiple chain ends each have an azide.

5. An improved dendrimer having a periphery with multiple chain ends, the multiple chain ends each being characterized by having a terminal acetylene.

6. An improved dendrimer having a periphery with multiple chain ends, the multiple chain ends each being characterized by having an azide.

7. An improved dendrimer having multiple terminal branch points and a periphery consisting of multiple terminal chains, each terminal chain corresponding to and being attached to one of the terminal branch points, each terminal chain having a chain end, each terminal chain being characterized by incorporating a [1,2,3]-triazole ring between its corresponding branch point and its chain end.
